(19) United States
(12) Patent Application Publication
(10) Pub. No.: US 2013/0071586 A1
(43) Pub. Date: Mar. 21, 2013

(54) Device for the Application of Foaming Materials

(71) Applicant: Herbert Munzenberger, Wiesbaden (DE)

(72) Inventor: Herbert Munzenberger, Wiesbaden (DE)

(21) Appl. No.: 13/624,357

(22) Filed: Sep. 21, 2012

(30) Foreign Application Priority Data
Sep. 21, 2011 (DE) 102011083084.7

(51) Int. Cl. E04B 1/66; B32B 1/08

(52) U.S. Cl. 428/35.2; 428/34.1; 428/35.7

(57) ABSTRACT

A device is described for the application of foaming materials in an opening of a building part. The device includes a body that accepts a foaming material. The body can be made from a deformable material and perhaps has an insert opening for the foaming material. The deformable material is deformable such that the deformable material does not hinder a foaming of the foaming material, but limits a foaming volume and a direction of foaming. This way a gap can easily be closed between an opening of a building part and a fire-prevention compartment in a fire and smoke-gas tight fashion.

### CROSS-REFERENCE TO RELATED APPLICATIONS

The present application claims priority to German Patent Application No. DE 10 2011 083 084.7, filed Sep. 21, 2011, which is hereby incorporated by reference herein in its entirety.

### BACKGROUND OF THE INVENTION

Some embodiments of the present invention relate to a device for the application of foaming materials in an opening of a building part and, in particular, a device with a body that includes a deformable material and perhaps an insert opening for the foaming material.

### BRIEF SUMMARY OF THE INVENTION

Some embodiments of the present invention provide a device for an application of foaming materials in an opening of a building part with a body that accepts the foaming material. The body can include, for example, a deformable material. In some embodiments, the body can include, for example, an insert opening for the foaming material. The deformable material can be deformable such that the deformable material does not hinder a foaming process of the foaming materials, but does limit a volume of a foaming and a direction of the foaming.

### DETAILED DESCRIPTION OF THE INVENTION

When remodeling public buildings, sometimes guide wires or pipes are guided through a building part such as a wall. The passage provided is then closed again. For a fire and smoke-gas tight closure, the passage is sealed with fire-preventing materials, such as fire-retarding stones, pillows filled with intumescent materials, or fire-prevention cement. Due to their simple installation, the fire-retarding stones have become common for sealing passages in building parts such as large passages. Such brick-shaped, fire-retarding stones are described in German Patent Document No. DE 199 14 371 C1. Intumescent fire-retarding stones are arranged loosely, like bricks, in a passage in a building part as well as around a line to be guided through and, in case of a fire, expand to a large extent and seal the opening in a fire and smoke-tight fashion.

The finishing of the sealing via the last row of fire-retarding stone can be problematic. The fire-retarding stone is installed in a compressed fashion to ensure the tightness with regards to fire and smoke-gas and to secure the fire-retarding stone from falling out unintentionally. Due to their design, particularly the consistency of their surface, which is frequently sticky and hard to slide as well as their plasto-elastic behavior, the stones are pressed into the remaining gap with great difficulty when the gap is smaller than the height of the fire-retarding stone.

This problem can be addressed by a vacuum stone. A fire-retarding stone, which includes a foamed material and shows pores, can be compressed by being packaged in a film that is subjected to a vacuum. This way, the stone only shows approximately ⅓ of its original height and/or volume and can easily be placed into the remaining gap of the opening in the building part to be sealed. When the vacuum package is pierced or scratched the stone expands to return to its original volume, thus sealing the entire compartment.

This can be disadvantageous in that the vacuum packed and compressed fire-retarding stones often lose their reset capabilities, particularly for extended storage. Accordingly, these stones cannot expand or only expand to an insufficient extent and thus the compartment is not compressed or insufficiently compressed so that the seal for fire and smoke is no longer ensured.

Another solution for sealing the gap between the opening in the building part and the compartment and for sealing the compartment includes sealing the gap with an expanding fire-prevention foam.

In this solution, it can be disadvantageous that the fire-prevention foam cannot be applied easily in all cases and only applies a low pressure upon the lower layers of the fire-retarding stones. It can be problematic in foaming materials that the developing foam expands in the direction of least resistance. In the case of sealing a gap between the opening in the building part and the last row of stones of a compartment, this means that the developing foam primarily expands towards the front out of the opening in the building part and towards the back in the opposite direction into the opening in the building part. Accordingly, the expansion pressure deflects so that the expansion pressure required to compress the compartment and thus sealing it, for example, towards the wall of the opening of the building part and the compartment, is of insufficient strength.

Some embodiments of the present invention therefore provide a device for the application of the foaming materials in an opening of a building part (e.g., a building part of the type described at the outset) which avoids at least some of the above-mentioned disadvantages. The device can include, for example, a body that accepts the foaming material, and provides a simple fire and smoke-gas tight sealing of the gap between the passage of the building part and a fire-prevention compartment.

The body that accepts the foaming material includes a deformable material, which is deformable such that it does not hinder the foaming of the foaming material, but limits the volume of foaming and the direction of foaming.

Using the device according to some embodiments, it is surprisingly possible to limit and/or direct the expansion volume and/or the direction of expansion of foaming materials (e.g., fire-prevention foam) so that more expansion pressure can be applied upon the wall of the opening in the building part and the last row of stones of the compartment.

The foaming material is not limited. Beneficially, the foaming material represents a fire-prevention foam, which is intumescent in case of fire and contributes to seal the opening in the building part in a fire and smoke-gas tight fashion. However, other foaming materials, which are not intumescent, may also be used, such as conventional construction foam for sealing gaps and grooves.

Preferably, the deformable body includes a flexible grid, which is preferred, or an elastic bag. The flexible grid can be made from plastic and, in particular, a thermoplastic such as polyethylene, which is preferred.

In an embodiment of the device according to the present invention, the flexible plastic grid is a tubular net with one end being closed and with its other end forming the insert opening. It is also possible for both ends to be closed, with then the option for an opening remaining or being created so that the foaming material can be inserted into the hose. Such openings may, for example, be given in the mesh openings of the net, through which the material to be foamed can be inserted. The ends may be closed, for example, via metallic clips or by way of welding, with other types of closures also being possible. This is advantageous in that the hose is simply closed on site and thus the length of the hose can be adjusted to the respective on-site conditions. It is not necessary for the insert opening to be located at the ends of the grid. The insert opening may be positioned at any other location.

Beneficially, the flexible plastic grid may show a mesh opening up to 15 mm in accordance with some embodiments. In some embodiments, when the mesh opening is greater, the foaming material exits through the mesh from the plastic grid so that the device cannot fulfill one of its functions, namely, to limit the foaming of the foaming material. However, in some embodiments, the mesh opening is at least of such a size that the foaming material can sufficiently expand and does not disturb one of its functions, namely, the sealing and the compression of the fire-prevention compartment. Accordingly, the flexible plastic grid shows a mesh opening W with 0<W−15 mm.

In some embodiments, the mesh opening relates to the unfilled and thus not expanded flexible plastic grid. As soon as the foaming material has been inserted into the plastic grid, it begins to foam and expand, which leads to the shape and the dimensions of the mesh of the plastic grid to change.

Preferably, the thickness of the material that includes the flexible plastic grid ranges from 0.2 mm to 3 mm, and preferably from 0.2 mm to 0.7 mm. At a material thickness exceeding 3 mm, the plastic grid is too stiff and thus inflexible so that any expansion of the foaming material is hindered and perhaps prevented entirely. This leads to the fire-prevention compartment no longer being sufficiently compressed, which compromises the smoke-gas seal and the stability of the fire-prevention compartment.

The length and the diameter of the flexible plastic grid can be selected depending on the width and the size of the gap to be sealed so that sufficient foaming material can be inserted into the gap to achieve a fire and smoke-gas tight sealing and to perhaps fulfill particular statutory or license-related requirements.

For a fire-prevention compartment in which a passage in a building wall is closed with fire-retarding stones, it has proven useful for the plastic grid to be approximately 30% longer than the installation depth of the fire-retarding stones according to some embodiments. The standard installation depth for such fire-retarding stones common in Europe for F90 to F120 licenses amounts to 200 mm and, for an F60 license, it is an installation depth of 130 mm. Accordingly, plastic grids were to be selected with a length from 260 mm (F90-F120) to 170 mm (F60). In the United States, 200 mm has been established for F180 licenses and 130 mm for F120 licenses, with the installation depth of the fire-retarding stones deviating therefrom in small and large compartments. Accordingly, plastic grids with a length of 260 mm (F180) and 170 mm (F120) were to be selected. The plastic grid may be pre-fabricated because, in most cases, the standard installation depths are selected. In such a manner, plastic grids can be produced in the appropriate length for each standard installation depth. Alternatively, it is also possible to size the length of the plastic grid on site as needed, for example, when no standard installation depths are selected, and be closed with material clips.

In the unexpanded state, for example, prior to being filled with the foaming material, the hose may show a diameter from 6 mm to 300 mm. Preferably, the hose diameter amounts from 30 mm to 60 mm. This way, a foamed body develops including a foaming material and the flexible plastic grid with a diameter from 90 mm to 200 mm if the foaming material can only expand within the limits set by the plastic grid. However, when used in a fire-prevention compartment, the volume of expansion depends on the size of the gap to be sealed and the counter pressure applied by the fire-retarding stones.

In an embodiment of the device according to the present invention, the elastic bag represents a hose with one of its ends being closed and with its other end forming the insert opening. Beneficially, only one end is closed. If both ends are closed, then another opening is created to insert the foaming material. It is advantageous that the length of the tube can be adjusted on site for particular circumstances.

The size of the bag can also be selected depending on the width and size of the gap to be sealed so that sufficient foaming material can be inserted into the gap to achieve a fire and smoke-gas tight sealing and to perhaps fulfill particular statutory or license-related requirements.

Preferably, the insert opening represents a nozzle or a hose through which the foaming material can easily be inserted into the body of the device according to an embodiment of the present invention. The nozzle or the hose can be embodied in one piece with the body or integrated therewith, for example, as an accessory.

Some embodiments of the present invention are better understood in view of the discussion of an example as set forth below.

A passage in a building part, through which subsequently lines must be conducted, is sealed with fire-retarding stones. The fire-retarding stones with a size of 200 mm×130 mm×5 mm (L×W×H) are installed longitudinally in the passage of the building part. To seal a remaining gap from 20 mm to 30 mm between the last row of stones and the wall of the passage in the building part in a fire and smoke-gas tight fashion, a flexible polyethylene-grid hose is inserted as a pre-fabricated device, welded at both sides and showing a diameter of 30 mm, a length of 270 mm, a mesh opening of 15 mm, and a material thickness of 0.2 mm to 0.7 mm at a slight distance from the lateral wall of the passage in the building wall in a corner of the compartment. Here, the grid hose is inserted into the gap to be sealed such that it is not flush with the front of the building part, but is located further inside the gap so that after an expansion has occurred not too much fire-prevention foam can ooze out of the gap towards the front.

The grid hose is filled via a mesh opening with a foaming fire-prevention mass, such as Hilti® CP620 Brandschutzschaum. Subsequently, it is waited until the foam has expanded. This way the circumference of the grid hose increases and the length reduces, with the expansion pressure being primarily directed by the grid hose radially outwardly and thus against the row of fire-retarding stones and the walls of the passage of the building part.

Subsequently, another grid hose is inserted in the gap at a slight distance and also filled with fire-prevention foam or mass. This step is repeated until the entire gap is sealed.

By the expansion pressure of the foaming mass, the gap is sealed in a fire and smoke-gas tight fashion and the compartment is compressed. Due to the grid hose, the expansion of the fire-prevention foam is limited in the direction of the gap opening and into the interior of the gap.

The fire-prevention foam partially passes through the mesh openings of the grid hose, with this not hindering the functioning of the grid hose. When the mass that has oozed out of the gap is cured it can easily be post-processed with a knife and be adjusted to the surface of the compartment and the building part.

While particular elements, embodiments, and applications of the present invention have been shown and described, it is understood that the present invention is not limited thereto because modifications may be made by those skilled in the art, particularly in light of the foregoing teaching. It is therefore contemplated by the appended claims to cover such modifications and incorporate those features which come within the spirit and scope of the present invention.

1. A device for applying foaming materials in an opening of a building part, comprising:
a body configured to accept a foaming material, wherein the body includes a deformable material, wherein the body has an insert opening for the foaming material, and wherein the deformable material is deformable such that the deformable material does not hindering a foaming process of foaming materials and does limit a volume of foaming and a direction of foaming.

2. The device according to claim 1, wherein the body includes a flexible grid or an elastic bag.

3. The device according to claim 2, wherein the flexible grid is a flexible plastic grid.

4. The device according to claim 3, wherein the flexible plastic grid is part of a flexible plastic grid hose, and wherein the flexible plastic grid has a first end that is closed and has a second end that forms the insert opening.

5. The device according to claim 2, wherein the elastic bag is part of a closed hose, and wherein the elastic bag has a first end that is closed and has a second end that forms the insert opening.

6. The device according to claim 3, wherein the flexible plastic grid has a mesh opening W in which 0 mm<W≦15 mm.

7. The device according to claim 3, wherein the flexible plastic grid has a material thickness from 0.2 mm to 3 mm.

8. The device according to claim 3, wherein the flexible plastic grid has a diameter from 6 mm to 300 mm.

9. The device according to claim 4, wherein a length of the flexible plastic grid hose depends on an installation depth of a fire-prevention compartment, and wherein the length is 30% longer than the installation depth.

10. The device according to claim 1, wherein the insert opening is a nozzle or a hose.

11. The device according to claim 10, wherein the nozzle or the hose is formed in one piece with the body.

12. The device according to claim 1, wherein the foaming material includes foaming fire-prevention mass.

13. The device according to claim 1, wherein the body part is configured, at least in part, as a flexible polyethylene-grid hose that is inserted into the building part.

14. The device according to claim 1, wherein the body part is configured, at least in part, as a flexible hose that is inserted into a gap between fire-retarding stones and a wall of a passage in the building part to seal the gap.

15. The device according to claim 14, wherein the gap is sealed to provide a fire and smoke-gas tight seal.

16. The device according to claim 14, wherein, as the foaming material expands, a circumference of the flexible hose increases and expansion pressure is directed radially outward by the flexible hose against the fire-retarding stones and the wall of the passage of the building part.

17. The device according to claim 14, wherein an expansion of the foaming material is limited in the direction of a gap opening and into an interior of the gap.

18. The device according to claim 1, wherein the body part is configured, at least in part, as a flexible-grid, thermoplastic hose.

19. The device according to claim 1, wherein the foaming material includes a fire-prevention foam.

20. The device according to claim 1, wherein the foaming material is intumescent.
